(19) United States
(12) Patent Application Publication
(10) Pub. No.: US 2025/0310463 A1
(43) Pub. Date: Oct. 2, 2025

(54) PRINTING DEVICE, PRINTING METHOD, AND IMAGE PROCESSING DEVICE

(71) Applicant: SEIKO EPSON CORPORATION, Tokyo (JP)

(72) Inventors: Toshiaki KAKUTANI, Shiojiri (JP); Hirotaka MATSUNAGA, Matsumoto (JP)

(21) Appl. No.: 19/087,696

(22) Filed: Mar. 24, 2025

(30) Foreign Application Priority Data
Mar. 26, 2024 (JP) 2024-049358

(51) Int. Cl. H04N 1/405; B41J 2/21

(52) U.S. Cl. CPC H04N 1/4051; B41J 2/2139; H04N 1/4057

(57) ABSTRACT

A printing device acquires a position of a missing dot in which, despite a position where a dot is to be formed, the dot cannot be formed by the head, performs halftone processing of generating dot data indicating whether to form a dot, using image data including a plurality of pixels having a plurality of tone values and a dither mask including a plurality of thresholds, searches for a threshold used in generation of a dot in a range near the missing dot, modifies a value of a change threshold, which is a threshold satisfying a search condition of being higher than a value of a target threshold, which is a threshold used at the position of the missing dot, to a value equivalent to the value of the target threshold, and provides the modified threshold for the halftone processing at the pixel corresponding to the modified threshold.

The present application is based on, and claims priority from JP Application Serial Number 2024-049358, filed Mar. 26, 2024, the disclosure of which is hereby incorporated by reference herein in its entirety.

### BACKGROUND

### 1. Technical Field

The present disclosure relates to a printing technology in which halftone processing using a dithering method is performed.

### 2. Related Art

When liquid droplets are ejected from a plurality of nozzles to perform printing on a medium, due to trouble such as clogging of the nozzles, liquid droplets may not be ejected to a specific site and a white stripe-like defect may appear in the printed image. A technique is known in which, when such a dot omission occurs, liquid droplets are ejected at pixels around the line where dots are missing so as to make the missing dots less visible, thereby suppressing deterioration in image quality. In order to modify the mode of ejection of liquid droplets, a method of processing image data before halftone processing as described in JP-A-2017-109480 and a method of modifying dot data indicating the on and off of dots after halftone processing as described in WO2008/102591 are known.

In the technique disclosed in JP-A-2017-109480, the original image data is processed in such a way as to increase the tone value of a pixel near the position where a dot is mitting, of the pixels forming the image, and thus increase the probability of a dot being formed, or to increase the rate of use of a large dot when a head that can form large and small dots is used. In WO2008/102591, the dot data is modified in such a way that, for a pixel where a dot is missing due to a defective nozzle in charge of dot formation even when dots are to be formed based on the dot data after halftone processing, a substitute dot replacing the missing dot is formed at a pixel where a dot is not supposed to be formed, of pixels which a normal nozzle is in charge of, near the pixel of the missing dot.

JP-A-2017-109480 and WO2008/102591 are examples of the related art.

However, in the technique of JP-A-2017-109480, since a probabilistic control technique is used in which the probability of a dot being formed in a row near a defective nozzle row is increased, there is no guarantee that a substitute dot is formed with one-to-one correspondence near the missing dot, posing a problem in that a substitute dot may be formed at quite a distance from the missing dot. In particular, when the dithering method, in which the processing is simple and can be performed at a high speed, is used as the halftone technique, there is a problem in that the generation interval of substitute dots is unstable, causing the occurrence of an area where no substitute dot is generated or an area where excessive substitute dots are generated, in a cycle visible to the human eye.

The technique of changing the dot data after halftone processing has a problem in that dedicated processing of searching for a pixel where a dot is not formed near the pixel where a missing dot is generated and forming a substitute dot there needs to be added. Adding such processing leads to a drop in speed and an increase in cost due to an increase in the number of processes. Also, since a substitute dot is generated at a position different from the initial position, the position of the formed substitute dot is not necessarily a desirable position in terms of image quality. Therefore, it is pointed out that a fine adjustment technique such as increasing or decreasing the number of substitute dots generated or optimizing the generation position needs to be separately considered.

### SUMMARY

The present disclosure can be implemented as a printing device having a head that forms a dot on a medium. The printing device includes: a halftone processing unit that performs halftone processing of generating dot data indicating whether to form a dot, using image data including a plurality of pixels having a plurality of tone values and a dither mask including a plurality of thresholds; a missing position acquisition unit that acquires a position of a missing dot in which the dot cannot be formed by the head despite a position where the dot is to be formed according to the dot data; a modification unit that searches for a threshold used in generation of a dot in a predetermined range near the missing dot, modifies a value of a change threshold, which is a threshold satisfying a search condition of being higher than a value of a target threshold, which is a threshold used at the position of the missing dot, to a value equivalent to the value of the target threshold, and provides the modified threshold for the halftone processing at the pixel corresponding to the modified threshold; and a printing unit that drives the head according to the dot data.

The present disclosure can also be implemented as a method of forming a dot on a medium by a head and thus performing printing. The method includes: acquiring a position of a missing dot in which the dot cannot be formed by the head despite a position where the dot is to be formed; performing halftone processing of generating dot data indicating whether to form a dot, using image data including a plurality of pixels having a plurality of tone values and a dither mask including a plurality of thresholds; searching for a threshold used in generation of a dot in a predetermined range near the missing dot, modifying a value of a change threshold, which is a threshold satisfying a search condition of being higher than a value of a target threshold, which is a threshold used at the position of the missing dot, to a value equivalent to the value of the target threshold, and providing the modified threshold for the halftone processing at the pixel corresponding to the modified threshold; and driving the head according to the dot data.

The present disclosure may also be implemented as an image processing device that processes image data and converts the image data into dot data for forming a dot on a medium. The image processing device includes: a halftone processing unit that performs halftone processing of generating dot data indicating whether to form a dot, using image data including a plurality of pixels having a plurality of tone values and a dither mask including a plurality of thresholds; a missing position acquisition unit that acquires a position of a missing dot in which the dot cannot be formed despite a position where the dot is to be formed according to the dot data; and a modification unit that searches for a threshold used in generation of a dot in a predetermined range near the missing dot, modifies a value of a change threshold, which is a threshold satisfying a search condition of being higher than a value of a target threshold, which is a threshold used at the position of the missing dot, to a value equivalent to the value of the target threshold, and provides the modified threshold for the halftone processing at the pixel corresponding to the modified threshold.

### BRIEF DESCRIPTION OF THE DRAWINGS

FIG. 1 shows a schematic configuration of a printing device incorporating an image processing device according to an embodiment.

FIG. 2 is a flowchart showing an example of an image print processing routine executed by the printing device.

FIG. 3 is a flowchart showing an example of a halftone processing routine.

FIG. 4 illustrates an example of a dither mask used in halftone processing.

FIG. 5 is a flowchart showing an example of a threshold modification processing routine for modifying a threshold.

FIG. 6 illustrates an outline of replacement of a dither threshold in a first embodiment.

FIG. 7 is a flowchart showing an example of a dither threshold replacement processing.

FIG. 8 illustrates an outline of replacement of a dither threshold in a second embodiment.

FIG. 9 illustrates an outline of replacement of a dither threshold in a third embodiment.

FIG. 10 is a flowchart showing essential parts of processing in a fourth embodiment.

FIG. 11 is a flowchart illustrating an example of a threshold modification processing routine in a fifth embodiment.

FIG. 12 illustrates an outline of replacement of a dither threshold in the fifth embodiment.

FIG. 13 illustrates an outline of processing when a plurality of types of dots are formed.

### DESCRIPTION OF EMBODIMENTS

### A. First Embodiment

### (A1) Device Configuration

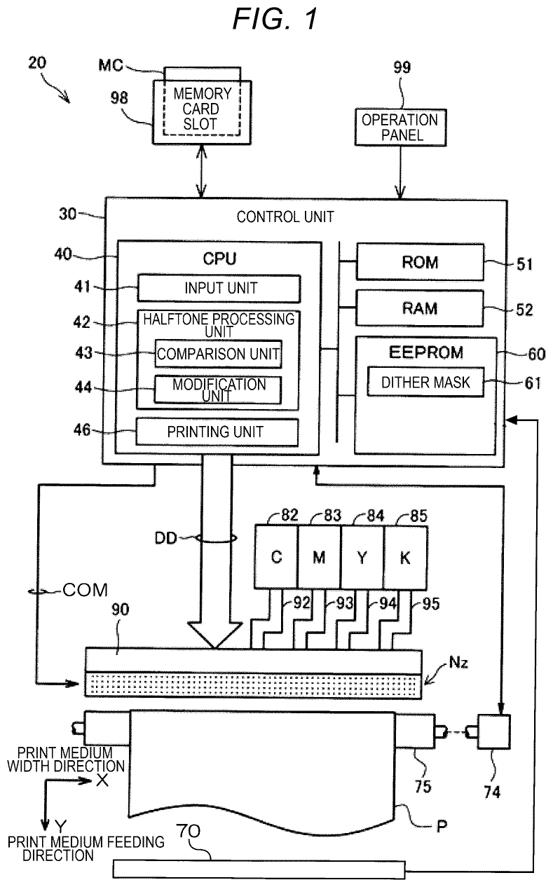

FIG. 1 shows a schematic configuration of a printer 20, which is a printing device. The printer 20 is a so-called line printer and is an inkjet printer using inks of four colors described later. As illustrated, the printer 20 has a mechanism that drives a paper feed roller 75 by a paper feed motor 74 so as to transport a medium P, a mechanism that drives a head 90 provided at a position facing the medium P so as to perform the ejection of the inks and the formation of a dot, and a detection device 70 that recognizes an image printed on the medium P. The printer 20 also has a control unit 30 that controls the exchange of signals between the detection device 70, the paper feed motor 74, the head 90, and an operation panel 99. In the present embodiment, the paper feed roller 75 also serves as a platen, but the platen may be a separate body from the paper feed roller. In this case, a flat platen having a flat surface may be used. The paper feed roller 75 may be provided both upstream and downstream of the head 90.

The detection device 70 is a line sensor that can recognize an image on the medium P with a higher resolution than the resolution of printing by the head 90, and from the image recognized by the detection device 70, a CPU 40 recognizes the position of a missing dot, which is a pixel of dot omission caused by the clogging of a nozzle Nz or the like, by processing described later. A missing dot acquisition unit is implemented, including the processing performed by the CPU 40 using the detection device 70.

In the head 90, a large number of nozzles Nz that can eject a cyan ink C, a magenta ink M, a yellow ink Y, and a black ink K as color inks are provided across the width direction of the medium P. Each of the plurality of nozzles Nz is provided with a piezo element, not illustrated, as an actuator. The piezo element is driven by a data signal DD corresponding to dot data and a drive signal COM. The actuator for ejecting the ink from the nozzle Nz is not limited to the piezo element, and various configurations such as a heater-type actuator that performs ejection by utilizing bumping of ink and a type that uses a laser can be employed. The formation of ink dots is not limited to the inkjet, and various methods such as a thermal transfer or thermal sublimation type using an ink ribbon, a method of forming a latent image on a photoconductive drum, or a serial printer that ejects ink from a nozzle while moving a print head forward and backward in the width direction of a medium can be employed.

The head 90 is supplied with each color ink from ink cartridges 82 to 85 for color inks that contain the color inks, respectively, via ink supply pipes 92 to 95. As the ink colors, a light cyan ink Lc, a light magenta ink Im or the like may be used in addition to the above CMYK. Of course, special color inks such as red, blue, and green may be used, and so-called metallic inks such as gold and pearl white may be used. Also, a head having an ink system for black-and-white printing may be employed.

The control unit 30 has the CPU 40, a ROM 51, a RAM 52, and an EEPROM 60, and has a configuration in which these elements are coupled to each other via a bus. The control unit 30 loads a program stored in the ROM 51 or the EEPROM 60 into the RAM 52 and executes the program, and thus controls the operations of the printer 20 as a whole and functions as an input unit 41, a halftone processing unit 42, and a printing unit 46. The functions of the halftone processing unit 42 include the functions of a comparison unit 43 and a modification unit 44. The operations of each of these units will be described later in detail.

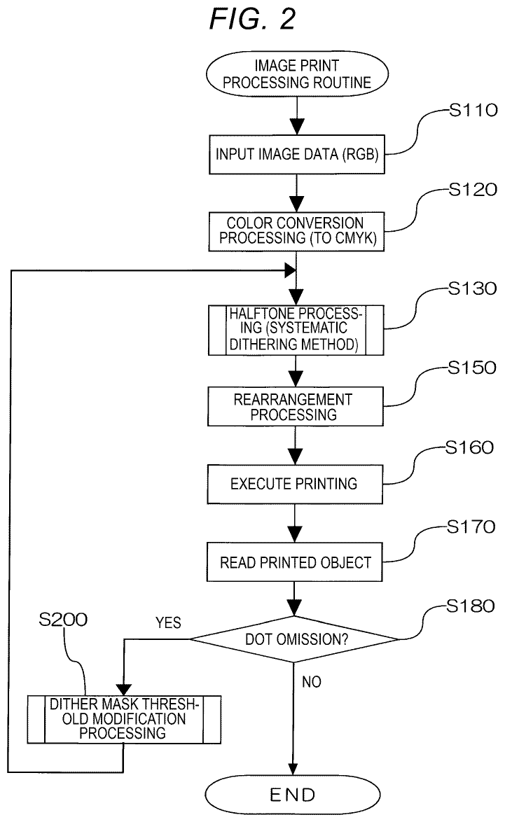

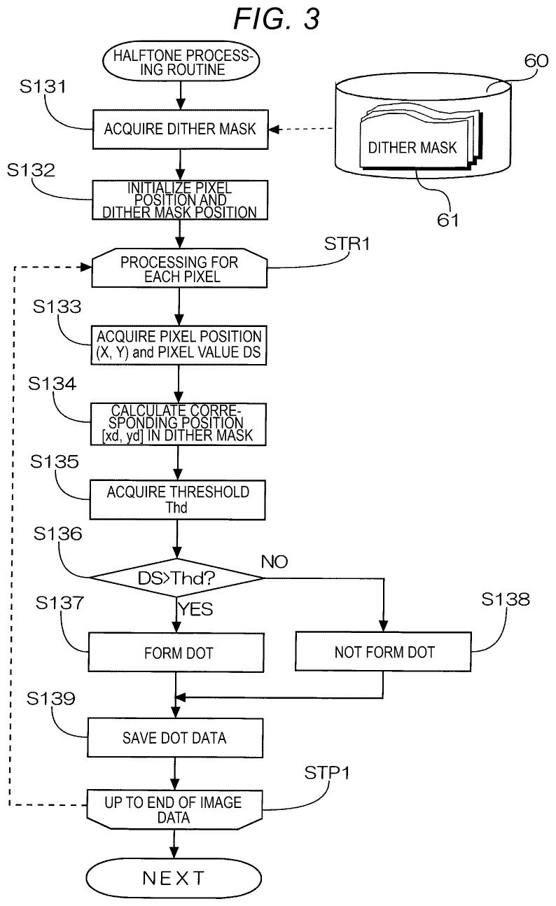

The printing unit 46 is a circuit for driving the head 90, and outputs the signal DD corresponding to dot data and the drive signal COM for driving the plurality of piezo elements at a time, to the head 90. The piezo elements are grouped for each of the CMYK colors, and are driven per group, based on the signal DD corresponding to dot data held in a latch, not illustrated, and the drive signal COM output at a predetermined timing. When the signal DD is on (dot data has a value 1) and the drive signal COM is given, the piezo element expands, pressurizes the ink in an ink chamber, not illustrated, and thus causes a liquid droplet to be ejected from the nozzle Nz. Since the printer 20 according to the present embodiment is a line printer, the nozzles Nz of the respective colors are arranged, shifted ata predetermined pitch in the feeding direction of the medium P. Also, in order to increase the resolution in the medium width direction, the nozzles Nz for the ink of the same color are arranged, shifted alternately in the medium feeding direction, that is, in a so-called staggered arrangement. Thus, the ejection timings of liquid droplets from the nozzles Nz when forming dots at the same position in the feeding direction of the medium P are different from each other. Therefore, as will be described later, rearrangement processing in which dot data acquired by processing tone data of an image to be formed is aligned with the nozzle arrangement is performed. Details of the processing of each functional unit including the processing by the printing unit will be described later with reference to the flowcharts of FIGS. 2 and 3 or the like.

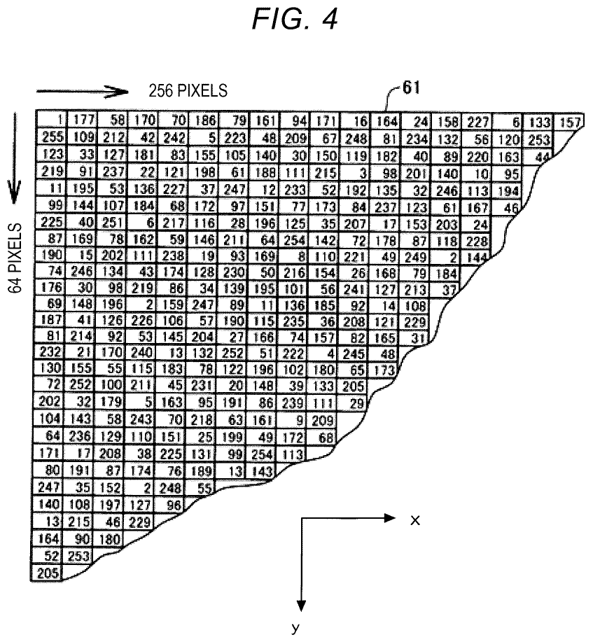

The EEPROM 60 stores a dither mask 61. The dither mask 61 is used in halftone processing, described later, and has a size of 256 pixels in the horizontal direction (xd: medium width direction)×64 pixels in the vertical direction (yd: medium feeding direction), as partly illustrated in FIG. 4. In the dither mask 61, a plurality of thresholds Thd are arranged. In the present embodiment, the threshold Thd takes the values of 1 to 255. Each threshold Thd is arranged in such a way that the spatial frequency of dots formed by comparison with the threshold is a so-called blue noise characteristic.

The blue noise characteristic in the dither mask has the largest frequency component in a high-frequency region where the length of one cycle is close to two pixels. This means that the storage position of the threshold is adjusted in such a way that the largest frequency component is generated in the high-frequency region in consideration of a human visual characteristic of having a low sensitivity in the high-frequency region. When dots are generated using the dither mask having the blue noise characteristic, an image with excellent dot dispersibility is obtained.

When the dither mask has blue noise characteristics, the distribution of dots to be formed has good dispersibility, and the granularity of the image is sufficiently suppressed. If the pixel size is sufficiently small, a good image with no granularity can be obtained even when the dither mask having a green noise characteristic having the largest frequency component on the slightly lower frequency side than the blue noise characteristic is used. The dither mask 61 has predetermined spatial frequency characteristics such as the blue noise characteristic and the green noise characteristic.

The size and the characteristics of the dither mask 61 may be freely determined, and a dither mask having a size and characteristics different from those in the embodiment can be employed. For example, the dither mask may have a size of 64×32 or more in order to implement a systematic dithering method, or may be a dot concentration-type dither mask that achieves characteristics close to halftone dots.

A memory card slot 98 is coupled to the control unit 30, and image data ORG can be read and input from a memory card MC inserted in the memory card slot 98. In the present embodiment, the image data ORG input from the memory card MC is data made up of color components of the three colors of red (R), green (G), and blue (B). The image data ORG may be acquired from a computer coupled via a wire or wirelessly connected, instead of from the memory card MC.

In the printer 20 having the hardware configuration as described above, while the paper feed motor 74 is driven to move the medium P in the feeding direction thereof, the head 90 is driven to form an ink dot of each color on the medium P. The control unit 30 drives the nozzle Nz at an appropriate timing based on print data in accordance with the feeding of the medium P, and forms an ink dot of an appropriate color at an appropriate position on the medium P. Thus, the printer 20 can print a color image input from the memory card MC, on the medium P.

### (A2) Print Processing

The print processing in the printer 20 will be described. FIG. 2 is a flowchart showing image print processing in the printer 20. This image print processing is started by the user performing a print instruction operation for a predetermined image stored in the memory card MC, using the operation panel 99 or the like. As the print processing is started, the CPU 40 first reads and inputs the image data ORG in the RGB format to be printed from the memory card MC via the memory card slot 98, as the processing by the input unit 41 (step S110).

When the image data ORG is input, the CPU 40 refers to a lookup table, not illustrated, that is stored in the EEPROM 60, and performs color conversion of the image data ORG from the RGB format to the CMYK format (step S120).

After performing the color conversion processing, the CPU 40 performs halftone processing of converting the image data into dot data that determines the on and off of dots of each color for each pixel, as the processing by the halftone processing unit 42 (step S130). Details of the halftone processing will be described later. In the present specification, the “halftone processing” is not limited to the binarization processing of the on and off of dots and means, in general, processing of converting (reducing) the number of tone levels including the multi-valued processing such as turning on and off large and small dots, or large, medium, and small dots, or the like. The image data used in step S130 may be image data on which image processing such as resolution conversion processing or smoothing processing is performed.

After performing the halftone processing, the CPU 40 performs rearrangement processing of rearranging the dot data into dot pattern data for simultaneously driving the nozzles Nz in the head 90 in accordance with the nozzle arrangement and the amount of paper feeding or the like in the printer 20 (step S150). The rearrangement processing is the processing in which the dot data obtained by the halftone processing (step S130) is rearranged in accordance with the arrangement of the nozzles Nz in the head 90, as described above. After performing the rearrangement processing (step S150), the CPU 40 drives the head 90, the paper feed motor 74, and the like to execute printing, as the processing by the printing unit 46 (step S160).

Thus, the printer 20 forms an image taken in from the memory card MC, on the medium P, but in the present embodiment, due to failure in ink ejection from the nozzle Nz, a dot omission may occur at a specific position in the width direction of the medium P, in the printed image, and a printed object in which a so-called white stripe is visible may be formed. In consideration of such cases, in the present embodiment, processing of reading the formed printed object is performed (step S170) after the execution of printing (step S160). The reading of the printed object is performed using the detection device 70. The detection device 70 is attached to the printer 20 with precise positioning thereto and has a resolution as a line sensor that is higher than (about twice) the resolution of the ink dots formed by the head 90, and therefore can accurately detect the position in the X direction where the dot omission is generated.

Then, based on the data read by the detection device 70, whether a missing dot due to a dot omission is visible to the side viewing the printed object is determined (step S180), and when no dot omission is generated or when a drop in image quality due to a dot omission is corrected by dither mask threshold modification processing, described later, and the dot omission is thus made invisible, the processing routine ends without taking any particular measure. Meanwhile, when it is determined that the dot omission is visible, threshold modification processing for the dither mask (step S200) is executed. In this case, the printer 20 executes the processing from step S130 onward again. That is, the halftone processing (step S130) by the systematic dithering method, the rearrangement processing (step S150), the execution of printing (step S160), and the reading of the printed object (step S170) are performed, and the processing of step S180 is executed again.

Depending on the mode of the dot omission, the dot omission may be visible even if the processing from step S130 onward is performed again. In such a case, the threshold modification processing for the dither mask may be performed over an enlarged target range. When the dot omission occurs due to a plurality of consecutive noises, simply performing the threshold modification processing for the dither mask may not necessarily be able to make the dot omission invisible. In such a case, abnormality processing, not illustrated, may be called to perform the maintenance of the head 90 or the like. When it is determined that the dot arrangement is modified to such an extent that the dot omission is not visible, by the threshold modification processing for the dither mask (step S200) or the maintenance of the head 90 or the like, the processing routine ends. The printer 20 is assumed to be used to print the same image on a plurality of sheets, for example, several hundreds of sheets, and therefore performs high-speed printing on a large number of sheets based on a high-speed print processing routine, not illustrated, when it is determined that printing in the state where the dot omission is invisible can be performed. The medium P may be a single sheet of A4 or A3 or may be a long sheet such as roll paper, and in this case, the printer 20, which is a line printer, repeatedly forms the same image in the direction of the length of the medium P or forms a series of images in the direction of the length. The image used to detect the dot omission may be a dedicated image for detection.

### (A3) Details of Halftone Processing

The halftone processing will now be described in detail with reference to FIG. 3. As the halftone processing is started, first, the dither mask 61 to be used for the print processing of this time is acquired from among the dither masks 61 stored in the EEPROM 60 (step S131). As the dither mask 61, a plurality of types of dither masks having different sizes and noise characteristics or the like are prepared, and a dither mask suitable for an image to be printed is selected.

Next, processing of initializing the pixel position in the image to be subjected to the halftone processing and the read position in the dither mask is performed (step S132). The initial position of the pixel position is the top left of the image, and is the origin (0, 0) when the pixel position is expressed by (X, Y). As shown in FIG. 4, the initial position in the dither mask is expressed as [xd, yd], where the top left of the mask is defined as the origin [0, 0]. After each position is initialized in this manner, the processing from step STR1 to step STP1 is repeatedly executed for each pixel on all the pixels forming the image.

First, processing of reading the position (X, Y) of the pixel and a pixel value DS corresponding to the tone value of the pixel at that position is performed (step S133). Next, processing of calculating the position [xd, yd] of the corresponding threshold of the dither mask 61, based on the pixel position (X, Y), is performed. The position [xd, yd] of the threshold is found by the expressions (1) and (2) given below (step S134). mod (A, B) is a function that returns a remainder when a numerical value A is divided by a numerical value B. Since the size of the dither mask 61 in the present embodiment is 256×64, the equations (1) and (2) are given as follows:

$$xd = mod ( X , 256 ) \qquad ( 1 )$$

$$yd = mod ( Y , 64 ) \qquad ( 2 )$$

Based on the position [xd, yd] of the threshold in the dither mask 61 thus found, the threshold Thd of the position is acquired (step S135), and the threshold Thd and the pixel value DS are compared with each other (step S136). The comparison unit 43 is implemented by these processes. When the pixel value DS is larger than the threshold Thd, a dot is to be formed and the dot data DD is set to the value 1 (step S137), and when the pixel value Ds is equal to or smaller than the threshold Thd, a dot is not to be formed and the dot data DD is set to the value 0 (step S138). Then, the set dot data DD is sequentially saved. The above processing is repeated on the pixel position (X, Y) from the origin position (0, 0) to the terminal end position in the image subject to the halftone processing (steps STR1 to STP1). As a result of the above processing, the original image data ORG is converted into the dot data DD made up of the on and off of dots, and is saved for printing.

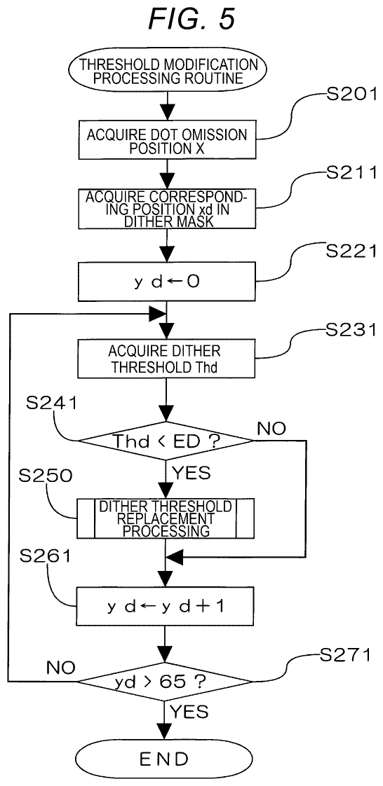

The threshold modification processing (step S200 in FIG. 2) when it is determined that the dot omission is visible will now be described with reference to FIG. 5. The CPU 40 executes this processing and thus implements the modification unit 44. In this processing routine for modifying the threshold, first, the position Xf of the dot omission is acquired (step S201). The position of the dot omission is the position of a missing dot where a dot cannot be formed by the head 90 despite the position where the dot is to be formed according to the dot data. The position Xf of the dot omission can be easily acquired, based on information acquired from the detection device 70. This processing corresponds to processing performed by a missing position acquisition unit. Next, processing of acquiring the position xd in the dither mask 61 in the halftone processing (FIG. 3) from the position Xf is executed (step S211). The position xd in the dither mask 61 is the position on the dither mask 61 providing the threshold Thd referred to when determining the on or off of the dot at the position Xf of the dot omission.

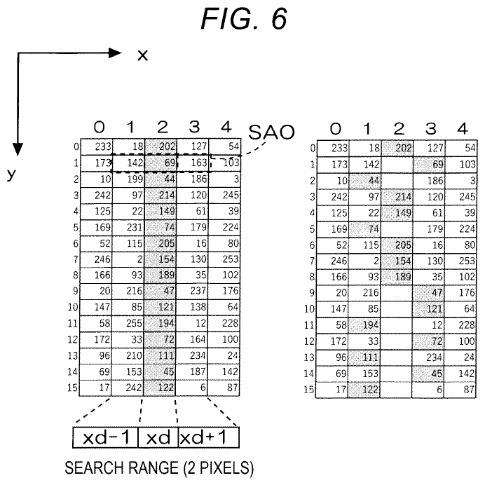

In the printer 20 according to the present embodiment, since one nozzle Nz is in charge of one row in the Y direction (vertical direction), the dot omission caused by the clogging of the nozzle Nz or the like occurs continuously at a specific position in the width direction of the medium P, that is, the X direction. Therefore, the position xd on the dither mask 61 corresponding to the position Xf of the dot omission is specified by the above equation (1), and the value 0 is set as the initial value for the position yd in the y direction (step S221). Then, the threshold Thd of the position [xd, yd] on the dither mask 61 is acquired (step S231). In order to describe an example of the modification processing for the dither mask 61, a part of the dither mask 61 is illustrated in FIG. 6. In this example, for example, when the position xd on the dither mask 61 corresponding to the position Xf on the image in which the dot omission occurs is the value 2, the value 202 is acquired as the threshold Thd in step S231 executed for the first time.

Next, whether the threshold Thd is smaller than a predetermined value ED is determined (step S241), and when the threshold Thd is smaller than the value ED (“YES” in step S241), dither threshold replacement processing (step S250) is performed, and when the threshold Thd is equal to or higher than the value ED (“NO” in step S241), the processing proceeds to step S261 without performing the processing of step S250. This is because of the following reason. In the printing using ink, an ink dot is circular as opposed to a rectangular pixel, and therefore when the proportion at which a dot is formed in a predetermined area is equal to or higher than a predetermined value, the density difference from the state where a dot is formed in an entire pixel is sufficiently small. Assuming that the proportion that achieves the sufficiently small density difference is, for example, 78% or more, in the printer 20 according to the present embodiment, this is equivalent to the case where the input tone value DS is 200 or more. That is, when the threshold Thd of the dither mask 61 is equal to or higher than the value ED (the value 200), it can be said that the formation of a dot at the pixel is limited to the case where the pixel value DS, which is the input tone value of the pixel, exceeds the threshold of 200 or more, and that there is no significant problem even if a substitute dot is not generated for the pixel. Thus, in step S241, the threshold Thd is compared with the value ED (in this example, the value 200), and when the threshold Thd is equal to or higher than the value ED, the threshold replacement processing for generating a substitute dot is omitted even when the dot omission occurs.

Taking FIG. 6 as an example, the threshold Thd of the position [xd, yd]=[2, 0] is the value 202, and therefore the determination in step S241 is “NO” and the threshold replacement processing (step S250) is not executed. In the case of the position [xd, yd]=[2, 1], the threshold Thd is the value 69 and therefore the threshold replacement processing (step S250) is executed. As the value ED used for such determination, an appropriate value may be selected by the ink system. Also, the determination in step S241 may not be performed and the dither threshold replacement processing (step S250) may be performed on all the thresholds Thd. The dither threshold replacement processing will be described in detail later.

Regardless of whether to execute the dither threshold replacement processing (step S250), subsequently, the value yd in the y direction of the dither mask 61 that is the target of the determination is incremented by value 1 (step S261) and whether the value yd exceeds the value 65 is determined (step S271). When the value yd does not exceed the value 65, the processing returns to step S231 and the above processing (steps S231 to S271) is repeated from the acquisition of the dither mask 61. When the value yd indicating the position in the y direction of the threshold exceeds the value 65, it is regarded that the processing for all the thresholds Thd arranged in the y direction of the dither mask 61 is complete, and this processing routine ends.

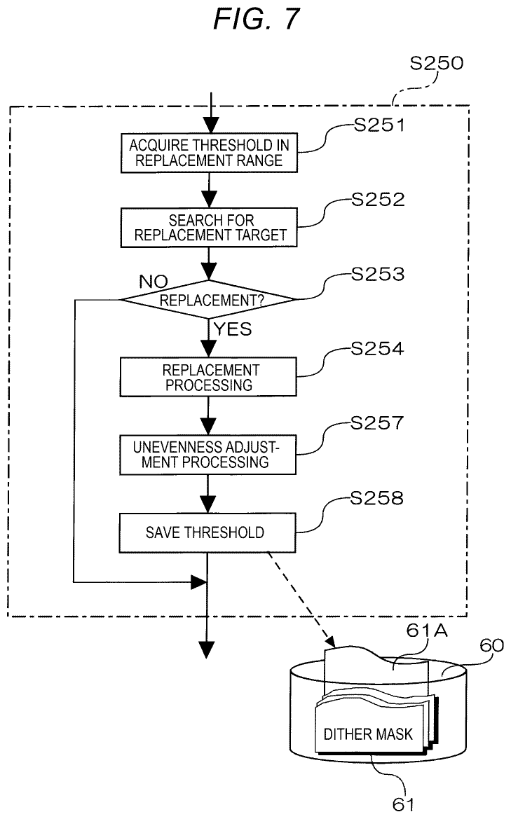

The dither threshold replacement processing (step S250) in the threshold modification processing will be described in detail with reference to FIG. 7. In the following description using an example of the replacement of the threshold, FIG. 6 is referred to as appropriate. In the threshold replacement processing, first, the threshold in the replacement range is acquired (step S251). While the replacement range can have various sizes and forms, in the first embodiment, the replacement range is a range corresponding to both sides of the pixel position Xf in the X direction on the image where the dot omission occurs, that is, a position (Xf−1) immediately before in the X direction and a position (Xf+1) immediately next in the X direction. This is shown as a replacement range SAO in FIG. 6. In the first embodiment, in step S251, the thresholds of the position [xd−1] and the position [xd+1] in the dither mask 61 corresponding to the pixel at the position to be replaced are acquired. In the example illustrated in FIG. 6, when the position yd in the y direction has the value 1, the threshold Thd of the position [xd, 1] is the value 69, and the thresholds Thd of the two positions in the replacement range SAO are the value 142 and the value 163.

Next, processing of searching for a threshold to be the replacement target is performed (step S252). This processing refers to searching for thresholds higher than the threshold of a position of interest from among the thresholds in the replacement range SAO and searching for the highest threshold of these thresholds. When only one threshold higher than the threshold of the position of interest is found in the replacement range, this threshold is the replacement target, and when two such thresholds are found, the threshold having a higher value is the replacement target. When the plurality of thresholds have the same value, any one of these may be selected, or a threshold that is not to be adjusted in unevenness adjustment processing (step S257), described later, may be selected. After the search for the threshold to be the replacement target is performed, it is determined whether to perform the replacement (step S253). When the threshold to be the replacement target is found, the determination is “YES”, and the replacement processing of replacing the threshold of the maximum value within the replacement range with the threshold of the position of interest is performed (step S254). In the replacement range SAO shown in FIG. 6, when yd=1, the two replacement targets are both higher than the threshold of the position of interest and the threshold 163 of the replacement position [xd+1, 1] is the highest in the replacement range, and therefore this is replaced with the threshold 69 of the position [xd, 1]. Similarly, when yd=2, the threshold 199 of the replacement position [xd−1, 2] is replaced with the threshold 44 of the position [xd, 2]. In the present specification, the “replacement” or the “replacement processing” means processing of modifying the replacement target, that is, the threshold 163 in the replacement range SAO when yd=1, to a value equivalent to the value 69 of the threshold of the position corresponding to the pixel of interest (hereinafter referred to as a target threshold), and whether to perform processing of replacing the target threshold with a change threshold, which is the threshold of the replacement target, does not matter. Since a dot is not formed at the pixel of interest even when the target threshold is replaced with the change threshold, whether to perform the replacement does not influence the formation of a dot. The value equivalent to the value of the target threshold is usually the same value as the target threshold Thd, but a value within a range that does not cause any significant difference in the result of the halftone processing using the dither mask may be used as the equivalent value. For example, a value in the range of the threshold Thdto may be used. In this example, x may be the value of the threshold Thd x several percent. This is because the dither threshold replacement processing (step S250) compensates for the drop in the image quality due to the missing dot where the dot omission occurs, and the drop in the image quality due to the missing dot is suppressed even when the modified value of the threshold is slightly different from the target threshold.

After the above replacement processing is performed, the unevenness adjustment processing (step S257) is performed, and the result is saved as a new dither mask 61A that applies the replaced threshold to the site of the dot omission (step S258). The unevenness adjustment processing (step S257) is processing of adjusting an uneven distribution of dots occurrence sites due to the threshold replacement when it is determined that there is a risk of such an uneven distribution. In the first embodiment, at the position yd=13, the threshold of the highest value of the thresholds found by the search, that is, the value 234, which is the threshold of the position [xd+1, yd] is the replacement target according to the replacement condition, but it can be understood that, if the replacement is performed directly, the replacement of the threshold occurs also at the position [xd+1, yd−1] at this time point, and if the replacement at the position yd=14 is considered in advance, the replacement of the threshold occurs also at the position [xd+1, yd+1]. In this case, dots are more likely to be formed consecutively in the Y direction, and therefore in the unevenness adjustment processing (step S257), at the position yd=13, the replacement with the threshold of the position [xd−11, yd] is performed instead of the replacement with the threshold of the position [xd+1, yd], and the dot formation state is thus adjusted. As a matter of course, such adjustment processing may be performed after the threshold replacement processing is once performed on all the target thresholds, or may be executed after the magnitude of the thresholds at three consecutive pixels in the Y direction is checked, as described above. Also, the adjustment processing may not be performed. When it is determined in step S253 that there is no replacement (“NO” in step S253), steps S254 to S258 are not executed and the dither threshold replacement processing (step S250) ends.

After the dither threshold replacement processing (step S250) ends, the position yd of the threshold is incremented by the value 1 and the above-described processing is repeated until the processing is finished on the thresholds of all the positions yd in the y direction, as shown in FIG. 5. As a result, the threshold Thd for determining the position Xf in the X direction where the dot omission occurs and the on and off of the dots before and after that position is replaced with a threshold that makes it more likely that the dot that is not formed at the position of the dot omission is formed before and after the position of the dot omission. In the example shown in FIG. 6, when the position yd has the values 1, 2, 5, or 9 to 15, the highest threshold is replaced with a relatively low threshold of the position of interest before and after the position where the dot omission occurs. This state can be easily understood from FIG. 6.

### (A4) Effects of First Embodiment

In the printer 20 according to the first embodiment described above, when a dot omission occurs due to the clogging of the nozzle Nz or the like in the head 90 and a white stripe or the like appears on the medium P, the position of the dot omission is specified, and the threshold of the corresponding position in the dither mask 61 is replaced in such a way that a dot is more likely to be formed around the pixel position where the dot omission occurs. Therefore, in the subsequent printing, the printing can be continued while suppressing the influence of the dot omission. Also, once the threshold is replaced, the halftone processing does not take extra time because the halftone processing itself based on the dithering method is left as it is. Therefore, the printing can be performed while performing the halftone processing at a high speed.

Also, in the processing of replacing the threshold, the threshold used for determining whether to form a dot at the pixel where the dot omission can occur is used to replace the threshold used for determining whether to form a dot at the pixels before and after that pixel, and therefore the processing is advantageous in that the result of the determination about the dot formation at the pixel where the dot omission can occur and the result of the determination about the dot formation at the pixel where the threshold is replaced are more likely to be the same. Therefore, not only the generation of white stripes and the like due to the dot omission is suppressed, but also the drop in the image quality is suppressed. Also, since the search range for the replacement target is two pixels before and after the pixel of interest, the processing is easy and the time taken for the processing can be shortened.

### B. Second Embodiment

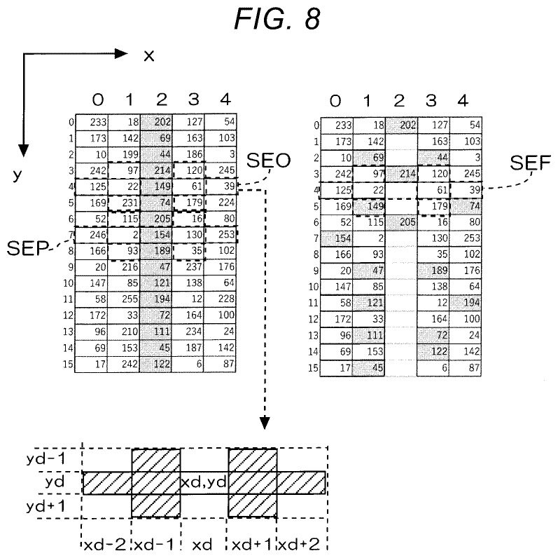

The printer 20 according to a second embodiment has a hardware configuration similar to that of the first embodiment and the outline of the processing to be executed is similar as well, but in the second embodiment, the replacement range in the dither threshold replacement processing shown in FIG. 7 is different. FIG. 8 illustrates the replacement range in the second embodiment and the state of the actually performed replacement. In the second embodiment, as illustrated, a range including thresholds corresponding not only the two pixels before and after the pixel of interest in the X direction but also the two pixels before and after these pixels, and the four pixels at so-called oblique positions shifted in both the X direction and the Y direction as viewed from the pixel of interest, that is, a total of eight pixels, is regarded as the replacement range SEO. In terms of the position in the dither mask 61, when the threshold corresponding to the pixel of interest is at the position [xd, yd], the eight positions given below form the replacement range SAO. The eight positions may be collectively handled or may be divided into some groups. In the first embodiment, the eight thresholds are collectively handled, and the threshold that is higher than the target threshold Thd and is the highest of the eight thresholds is searched for.

The condition for performing the replacement may be, for example, that the threshold is not a threshold that is already replaced before this processing, that the threshold is a threshold having a higher value than the target threshold Thd, and that the threshold has the highest value in the replacement range SEO, or the like. As threshold corresponding to the pixel for which the replacement is already performed is excluded from the replacement determination target, unnecessary processing is not performed and the processing speed can be increased. In the illustrated example of the second embodiment, since the replacement range is enlarged, the replacement of the threshold is performed also at the positions yd=4, 7, and 8 in FIG. 8, and the influence of the dot omission can be suppressed further. For example, in the case of the position yd=4, in the replacement range SEO, the threshold 231 of the position [xd−1, yd+1] satisfies the replacement condition and the replacement is performed. The result of the replacement is shown as a range SEF.

In this way, when the replacement range SEO is enlarged, the number of targets where the threshold can be replaced is increased and the influence of the dot omission can be suppressed further. In the second embodiment, the position of the dot generated by replacing the threshold is not limited to the adjacent columns to the left and right of the pixel of interest, and a dot is also formed at the positions further on the outer side [xd±2, yd]. As in the second embodiment, when the replacement range is enlarged and the threshold to be the replacement target is searched for in order from the inner side, the generation ratio drops as the distance from the pixel of interest increases, but a dot compensating for the dot omission is also formed in a column that is away to a certain extent. Therefore, trouble such as excessive generation of dots in the left and right columns adjacent to the pixel of interest, making the dots more likely to be vertically connected and form a visible stripe, is suppressed. When the output resolution of the printer 20 is high, a dot compensating for the dot omission may be formed up to a column that is further away.

In the example shown in FIG. 8, as in the first embodiment, the unevenness adjustment processing (step S257) is performed, making it less likely that dots are formed consecutively in the vertical direction. Specifically, when the threshold corresponding to the pixel of interest is at the position [2, 7], the search range of the threshold to be the replacement target is eight pixels in the replacement range SEP, and when the maximum threshold is simply searched for, the threshold 253 of the position [4, 7] is selected, but in this case, in the column of xd=4, the threshold of the position [5, 7] is replaced and a dot compensating for the dot omission may be formed closely. Therefore, in order to prevent the occurrence of dots from being unevenly concentrated in the column of xd=4, the unevenness adjustment processing is performed, selecting the threshold 246 of the position [0, 7] as the change threshold, and replacing this with the threshold 154 corresponding to the pixel of interest, so as to suppress the likelihood that dots may be generated closely in the same column.

As described above, the search range of the replacement target of the dither threshold in the second embodiment is three positions each in the columns to the left and right of the target threshold (in the replacement range SEP, the positions [1, 6], [1, 7], [1, 8] and [3, 6], [3, 7], [3, 8]) and one position each on both sides that are one position apart from the threshold corresponding to the pixel of interest (in the replacement range SEP, the positions [0, 7] and [4, 7]), and therefore in a simple estimation of the ratio of dots formed to compensate for the dot omission, the ratio of dots formed in the adjacent column is three times the ratio of dots formed at the positions on both sides that are one position apart. Therefore, the occurrence of the dot omission is compensated for and the occurrence of the white stripe or the like is suppressed, and the problem of excessive dots being formed closely to the occurrence site of the dot omission and being conspicuous is suppressed as well.

### C. Third Embodiment

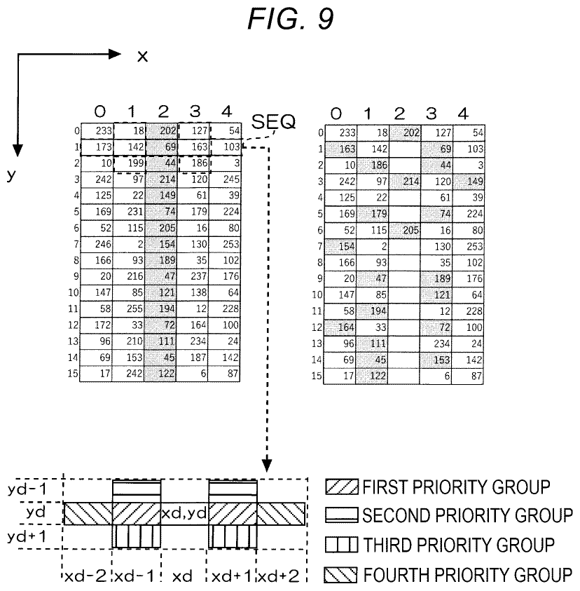

The printer 20 according to the third embodiment has a hardware configuration similar to that of the first embodiment, and the outline of the processing to be executed is similar as well, but in the third embodiment, the dither threshold replacement processing (step S250 in FIG. 7) in the dither threshold modification processing (step S200) is different in being repeated a plurality of times, depending on the case. FIG. 9 illustrates the replacement range in the third embodiment and the state of the actually performed replacement. In the third embodiment, as illustrated, a range including thresholds corresponding to not only the two pixels before and after the pixel of interest in the X direction but also the two pixels before and after these pixels, and the four pixels at the positions shifted in both the X direction and the Y direction as viewed from the pixel of interest, that is, a total of eight pixels, is regarded as the replacement range SEO, as in the second embodiment. Moreover, the search range is grouped as follows.
First priority group [xd−1, yd], [xd+1, yd]
Second priority group [xd−2, yd], [xd+2, yd]
Third priority group [xd−1, yd−1], [xd+1, yd−1]
Fourth priority group [xd−1, yd+1], [xd+1, yd+1]

Then, the target threshold Thd corresponding to the pixel where the dot omission occurs is compared first with the thresholds of the first priority group, and when a threshold higher than the target threshold is found among these thresholds, the replacement processing is performed, whereas when such a threshold is not found, the search is performed in order, for example, the search through the thresholds of the second priority group is performed, and when such a threshold is not found even in the second priority group, the search through the third priority group is performed.

The search is performed per group in this way, and in the third embodiment, the following processing (1) and (2) are repeated in the dither threshold replacement processing until the end condition is satisfied.

(1) The threshold of the replacement range SEQ is sequentially searched from the first priority group, and when a threshold higher than the target threshold is found, this threshold is set as the target threshold and replaced with the target threshold, and (2) the threshold before the replacement at the replaced position, that is, the change threshold, is acquired, and the replacement range SEQ is searched further, and when a higher threshold is found, the threshold is replaced.

In this way, in the third embodiment, when performing the search through the replacement range SEQ, the search range is divided into a plurality of groups and the replacement pixels are sequentially searched. At this time, in the third embodiment, instead of searching for the highest threshold in the replacement range SEQ to be searched, when there is a threshold that satisfies the condition of being higher than the target threshold (the value 69 in the illustrated example) in the group being searched, this threshold is set as the change threshold and is selected as the replacement target. This is because, even with a threshold having a small difference from the target threshold, the disturbance in the dot arrangement can be reduced when dots are formed near the pixel of interest. When the replacement range SEQ is searched, unlike the examples illustrated in FIGS. 6 and 8, the threshold 163 of the position [3, 1], instead of the threshold 173 of the position [0, 1], is determined to satisfy the condition and is replaced with the target threshold 69 (first stage).

In the present embodiment, since the search is not finished yet for all the thresholds in the replacement range SEQ, the search is continued to determine whether there is a threshold having a higher value than the original threshold 163 of the replaced position [3, 1], in the replacement range SEQ. As a result, the threshold 173 of the position [1, 0] is replaced with the threshold 163 (second stage). Such replacement is repeated until the end condition is satisfied. In the present embodiment, the end condition is that the comparison of all the thresholds in the replacement range SEQ is finished or that the threshold satisfying the conditions (1) and (2) is higher than the value ED. In this way, the processing of sequentially replacing a higher threshold nearby is repeated in a so-called domino style until the end condition is satisfied.

Thus, the formation of a substitute dot can be continued while the formation position of the dot for replacing the missing dot is changed. Also, since the difference between the original threshold and the threshold after the replacement can be reduced, the disturbance in the dot arrangement can be reduced. In the third embodiment, in such processing, overwriting is repeated until the threshold of the last replacement subject becomes equal to or higher than the value ED for the pixel of xd=2 where the dot omission occurs, and therefore when the input tone value is equal to or lower than the value ED, a substitute dot for the pixel of the dot omission can be securely generated. The number of times the replacement processing is added may be limited to one or two. Also, the replacement range SEQ may be extended to a position further away from the pixel where the dot omission occurs, for example, to a position three pixels away from the pixel or further.

### D. Fourth Embodiment

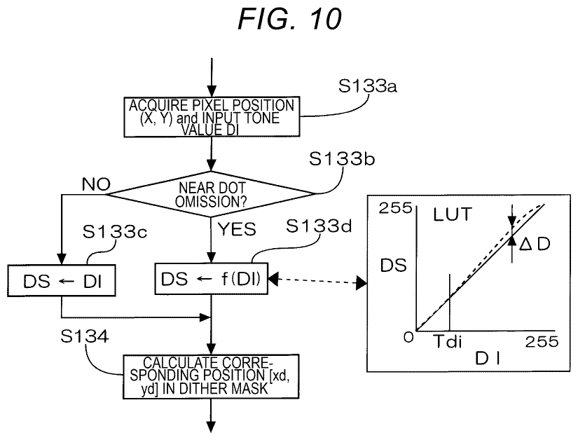

A fourth embodiment will now be described. The printer 20 according to the fourth embodiment similarly performs, except for a part of the halftone processing shown in FIG. 3, the other processing such as the dither threshold replacement processing as in various embodiments described as the first to third embodiments. In the fourth embodiment, as shown in FIG. 10, instead of step S133 in the halftone processing, processing of acquiring the pixel position (X, Y) and the input tone value DI of the pixel position (step S133a), determination of whether the pixel position is near the pixel position where the dot omission occurs (step S133b), and two types of processing (steps S133c and S133d) executed based on the result of the determination, are performed. Step S133c is processing of setting the input tone value DI as the pixel value DS as it is, and step S133d is processing of correcting the input tone value DI and setting the corrected input tone value DI as the pixel value DS. That the pixel position which is the target of the halftone processing is near the missing dot where the dot omission occurs, refers to a positional relationship in which the target pixel position is the pixel positions on both adjacent sides in the X direction to the pixel where the dot omission occurs. Of course, the term “near” is not limited to both adjacent sides and may include up to the pixel position outside thereof.

In the present embodiment, the correction of the pixel value DS is performed by referring to a lookup table LUT as described below, but the correction may be performed using a function or the like. In the correction of the pixel value DS, for example, no correction is performed when the input tone value DI is equal to or lower than a predetermined value Tdi (for example, the value 32), and the correction is started gradually from the predetermined value Tdi, and the pixel value DS corresponding to the input tone value DI is corrected to a large value. The amount of correction ΔD increases as the input tone value DI increases. This is because, as the input tone value DI increases, the number of cases where the formation of a dots complementing the dot omission does not occur increases. The amount of correction ΔD is determined in such a way that the image to be actually printed becomes optimum. Thus, the amount of correction does not necessarily simply increase with the input tone value, and the pixel value DS may be reduced in relation to the input tone value DI. Such correction can be combined with any of the techniques in the first to third embodiments described above, but when the correction is combined with the third embodiment in particular, the dot formed to complement the dot omission is less likely to be insufficient and therefore there may be a case where the absolute value of the amount of correction ΔD is made smaller or the amount of correction ΔD is set to be a negative value, based on the input tone value DI, thus reducing the pixel value DS as a result.

The lookup table LUT used for the correction may associate the input tone value DI with the pixel value DS, or may associate the input tone value DI with the amount of correction ΔD. In the latter case, after the look-up table LUT is referred to, the acquired amount of correction ΔD may be added to or multiplied by the input tone value DI, thus finding the pixel value DS. The relationship between the input tone value DI and the pixel value DS may not be prepared in advance for the entire range of the input tone value DI. For example, in an example case where the input tone value DI takes an 8-bit value, that is, in a range of values 0 to 255, this range may be divided into a plurality of sections, for example, eight sections, and the relationship between the input tone value DI and the pixel value DS at nine division points of 0, 32, 64, and so on up to 255 may be determined in advance, and the pixel value DS in each range may be internally interpolated with the value at the division point. The interpolation may be linear interpolation, or curve interpolation using values at three or more adjacent division points.

The correction as described above may be performed, for example, on the pixels on both sides adjacent to the column where the dot omission occurs (“YES” in step S133b), or may be performed on the pixels further on the outer sides adjacent thereto. In this case, preferably, the contents of the lookup table LUT may be changed and optimized according to the distance from the pixel where the dot omission occurs. The amount of correction ΔD may be reduced for a pixel having a large distance, using one lookup table LUT, or a dedicated lookup table LUT may be prepared according to the distance.

According to the fourth embodiment described above, the degree to which a dot complementing the pixel where the dot omission occurs is formed near this pixel can be made even closer to an appropriate one. Therefore, the generation of a white stripe or the like due to the dot omission can be suppressed, the arrangement of the dots around the site can be made more reasonable, and the deterioration in the image quality can be suppressed.

The embodiment in which the pixel value DS of the pixel around the pixel where the dot omission occurs is compensated is described above, but similar advantageous effects can also be implemented by relatively correcting the dither threshold corresponding to the pixel in question. That is, the thresholds on both sides of the position [xd, yd] of the target threshold, that is, the thresholds of the positions [xd+1, yd] may be corrected. In this case, the relationship between the input side and the output side of the lookup table LUT may be interpreted in reverse and the correction may thus be made. That is, when the amount of correction ΔD of the pixel value DS of the pixel next to the pixel of interest is to increase the input tone value DI by the value a or by β%, the threshold may be decreased by a or by β%. In this way, the technique of correcting the corresponding threshold is advantageous in that there is no need to insert a new process of changing the input tone value and that the correction can be performed simply by setting the threshold. In this case, the threshold may be rewritten before the halftone processing, and the rewritten dither mask 61 may be saved in the EEPROM 60.

As the dither mask 61 is corrected in this way, it is sufficient to modify the thresholds (see FIG. 4), for example, for 64 pixels arranged in the y direction. Therefore, the pixel value DS need not corrected for all the pixels corresponding to the position of the dot omission forming the image data. Also, in the case of performing different corrections depending on the distance from the column of the dot omission, in the technique of correcting the pixel value, different correction tables need to be held in the halftone processing, depending on the distance, whereas in the technique of correcting the threshold, the threshold may be corrected before the execution of the halftone processing and there is no need to have a plurality of lookup tables LUT when executing the halftone processing.

### E. Fifth Embodiment

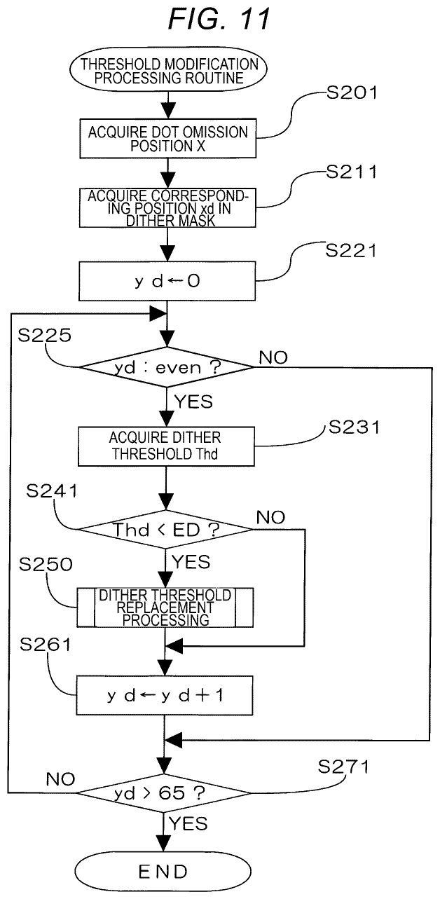

A fifth embodiment will now be described. The printer according to the fifth embodiment has the head 90 having two nozzle rows along the Y direction, each nozzle row including a plurality of nozzles Nz forming one ink color and arranged across the width direction (X direction) of the medium P, instead of the head 90 having one row each of a plurality of nozzles Nz forming one ink color and arranged across the width direction of the medium P. In this head 90, two nozzles Nz that eject liquid droplets of each color are present along the transport direction (Y direction) of the medium P, and when viewed along the transport direction of the medium P, the two nozzles Nz alternately form dots. Thus, missing dots as a result of a dot omission due to a defect in one nozzle Nz do not occur consecutively. That is, when a dot row formed consecutively in the width direction of the medium P is called a raster, the dot omission occurs every other raster. Therefore, the dither threshold modification processing, too, is performed in response to this. FIG. 11 is a flowchart illustrating an outline of such replacement processing on every other raster. In the fifth embodiment, the processing is the same as the dither threshold modification processing routine described with reference to FIG. 5 in the first embodiment, except that step S225 is newly provided. In step S225, whether the position yd of the target threshold in the dither mask 61 has an even number (even) is determined. This is the case where a dot omission occurs in the nozzle Nz in charge of even-numbered rows of the rasters. In this example, even in the same column in the image, dots are formed by different nozzles Nz between the rasters in the even-numbered rows and the rasters in the odd-numbered rows, and the dot omission occurs due to a defect in the nozzle Nz in charge of the rasters in the even-numbered rows. Which of the nozzle Nz in charge of the rasters in the even-numbered rows and the nozzle Nz in charge of the rasters in the odd-numbered rows has the defect can be easily determined by combining the amount of driving of the paper feed motor 74 driven by the processing of the CPU 40 and the result of detection by the detection device 70.

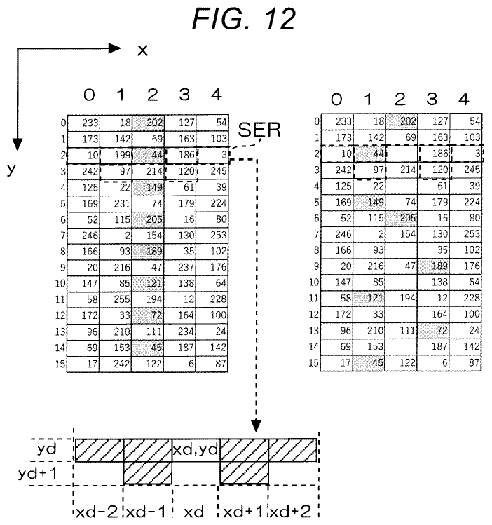

FIG. 12 shows the state of processing when the dot omission occurs due to the nozzle Nz in charge of the rasters in the even-numbered rows. In the illustration, the threshold to be the target of the replacement processing is indicated by hatching. The range in which the threshold replacement is performed is indicated as the replacement range SER surrounded by a dashed line. When the pixel of interest is at the position [xd, yd], the replacement range SER includes a total of six thresholds at the positions [xd+1, yd], the positions [xd+2, yd], and the positions [xd+1, yd+1]. The six thresholds are the targets of replacement. Therefore, the replacement ranges SER for the respective pixels of interest do not overlap each other. In this example, yd is an even number. The replacement range SER may be narrower or wider. For example, a range that defines eight thresholds including the positions [xd±2, yd+1] as targets may be employed. Further, as described in the first to third embodiments, the unevenness adjustment processing (step S257 in FIG. 7) may also be performed so that the formation of dots is not unevenly concentrated on a specific side.

According to the fifth embodiment described above, even when a plurality of nozzles are in charge of the formation of dots in one column, effects similar to those of the above-described embodiments can be achieved. Since the dot omission occurs only every other raster or at an interval of a plurality of rasters, the replacement of the threshold can further suppress the influence of the dot omission.

### F. Other Embodiments

(1) One of the other embodiments is a printing device having a head that forms dots on a medium. The printing device includes: a dither mask unit that prepares a dither mask including a plurality of thresholds used for halftone processing based on a dithering method; a halftone processing unit that compares an input tone value for each pixel forming image data with a threshold acquired according to a position of the pixel from the dither mask and thus converts the input tone value into dot data indicating whether to form a dot for each pixel; a printing unit that drives the head according to the dot data; a missing dot acquisition unit that acquires a position of a missing dot, which is a pixel where the dot is not formed by the head, from among on-pixels where the dot is formed; and a modification unit that searches for a threshold used for the comparison at a pixel in a predetermined range near the missing dot, and that, when a change threshold, which is a threshold satisfying a search condition of being higher than a value of a target threshold, which is a threshold used for the comparison at the position of the missing dot, is found, modifies the change threshold to the target threshold and provides the modified threshold for the comparison at the pixel corresponding to the modified threshold by the halftone processing unit. Thus, a dot is more likely to be formed near the missing dot, where a dot is not formed, and therefore the drop in the image quality due to missing dot can be suppressed. Also, since the threshold in the dither mask is modified, the drop in the image quality due to the missing dot, where a dot is not formed, can be suppressed more easily than when the input tone value is modified. The suppression of the drop in the image quality may be implemented simply by modifying the threshold or may be implemented by modifying the input tone value as well.

In the first to fifth embodiments, a line printer is used as an example of the printer 20, but the present technique can be implemented in a so-called serial printer, which forms an image while moving the head forward and backward in the width direction of the medium (hereinafter referred to as the main scanning direction). In this case, when a missing dot is generated for reasons such as the presence of a nozzle that cannot form a dot, among the nozzles arranged in the head, the array of the missing dots is along the main scanning direction. Therefore, in this case, the position (X, Y) of the missing dot is found by using the detection device 70, the position yd in the y direction on the dither mask 61 corresponding to the position in the Y direction where the missing dot is generated is found by the above-described equation (2), the threshold at the position yd in the y-direction is sequentially read in the x direction, and the threshold replacement processing may be performed as in the first to fifth embodiments. The replacement range in which the change threshold is searched for may be provided on both sides in the x direction instead of in the y direction.

In the case of a serial printer, one raster is completed by a forward and backward movement of the head, and in this case, one raster is formed with dots based on liquid droplets ejected from a plurality of nozzles. Therefore, in this case, as in the case described in the fifth embodiment, the target threshold may be taken out every other column or at an interval of a plurality of columns and may be compared with the threshold within the replacement range, thus performing the replacement processing.

As the head, a head that ejects liquid droplets to form an image, or a head that forms dots by other methods such as an ink melting type, a sublimation type, and a transfer type may be employed. As the actuator that generates a pressure change to eject liquid droplets, a configuration using a heater that heats ink and generates bubbles therein, or the like may be employed as well as a configuration using an electrostrictive element such as a piezo element.

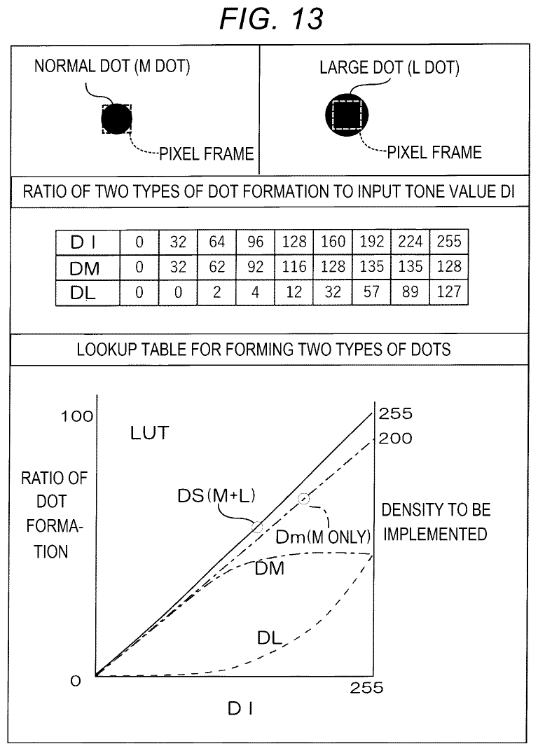

As the above-described head, a head of a type that forms a plurality of types of dots having different sizes may be used. The handling in the case of forming such dots having different sizes will be described with reference to FIG. 13. As an example, a head that can form two types of dots is used. As shown in the uppermost section in FIG. 13, this head can form a dot of a normal size (hereinafter referred to as an M dot) and a dot larger than that (hereinafter referred to as an L dot). The M dot is smaller than the size of the pixel frame. Therefore, when the input tone value DI is the value 255 and the M dot is formed at all the pixels, the density implemented on the medium P remains at a value of approximately 200, as compared with the value 255 when the medium P is fully filled with dots. Meanwhile, the L dot has a size circumscribing the pixel frame.

How the two types of dots are formed is defined by the M dot input tone value DM and the L dot input tone value DL. The M dot input tone value DM indicates the ratio of formation of the M dot to the input tone value DI of the image data, and the L dot input tone value DL similarly indicates the ratio of formation of the L dot, each in the range of values 0 to 255. That the ratio of formation is the value 255 means that a dot is formed at all the pixels, and in this case, the coverage rate of pixels is 100%. The relationship between the ratio of formation of each dot to the input tone value DI and the density to be implemented is illustrated in the lower section in FIG. 13. As illustrated, the M dot is formed to an extent corresponding to the input tone value DI, for up to the input tone value DI of approximately the value 64. As the M-dot input tone value DM exceeds the value 64, the rate of increase gradually drops, and when the input tone value DI exceeds the value 160, the M-dot input tone value DM becomes relatively stable values ranging from the value 128 to approximately the value 135 and ultimately becomes the value 128. Meanwhile, the L dot input tone value DL is the value 0 for up to the input tone value DI of the value 64, and then increases and takes the value of the difference between the input tone value DI and the M dot input tone value DM. As a result, the value of the L dot input tone value DL rapidly increases when the input tone value DI is the value 160 or more.

Thus, the M dots do not completely cover the pixel frame, and therefore when only the M dots are formed according to the input tone value DI, the implemented density remains at approximately 200/255, whereas when the M dots and the L dots are formed as illustrated according to the input tone value DI, the implemented density is 255/255. To reduce the ratio of the M dots and form the L dots, if a so-called continuous dither technique is used, a dither mask used for forming dots of a single type can be used as it is. Specifically, the formation of dots is determined in the following manner.

In each of the above-described embodiments, the dither threshold after the replacement processing of the target threshold around the pixel where the dot omission occurs is defined as The. At this time, it is determined that the L dot is to be formed if The<DL, that the M dot is to be formed if The≥DL and The<(DL+DM), and that no dot is to be formed if The≥DL and The≥(DL+DM). Thus, whether to generate the L dot and the M dot can be easily determined, reflecting the characteristic of one dither mask. A dither mask for the M dot and a dither mask for the L dot may be separately prepared.

Thus, the formation of dots using the technique according to the present disclosure can be performed with a printer that forms two types of dots having different sizes. In this case, even when the value ED, with which whether to perform the replacement of the target threshold at the pixel of interest, is equal to or sufficiently close to the maximum value of the input tone value, a dot that complements the influence of the dot omission is formed. This is because, since the ratio of forming dots near the pixel where the dot omission occurs cannot be increased to 100% or higher, the density, that is, the amount of ink, at the pixel near the pixel of the dot omission can be achieved by increasing the size of the formed dot instead of increasing the ratio of dot formation. The dot size is not limited to two types and may be three or more, such as large, medium, and small. Also, when a dark-colored ink such as a magenta ink or a cyan ink, and a light-colored ink lighter than the dark-colored ink, such as a light magenta ink or a light cyan ink, are used, the ratio of formation of the dark-colored ink may be increased or decreased. A similar effect can be achieved by arranging two or more dots at the same pixel position, instead of increasing the dot size.

(2) In above configuration, the the predetermined range may be a range including pixels on both sides of the missing dot in a direction intersecting an array of the missing dot. Thus, a dot for complementing the dot omission is made more likely to be formed near the missing dots.

(3) In the above configuration of (1) or (2), the predetermined range may be a range including a total of eight pixels made up of first and second pixels, which are pixels on both sides of the missing dot in a direction intersecting with the arrangement direction of the missing dot, third and fourth pixels, which are pixels further on the outer side of the pixels on both sides, and fifth to eighth pixels, which are pixels on both sides of the first and second pixels in the arrangement direction. Thus, the threshold other than those of the first and second pixels, which are pixels on both sides of the missing dot, can be modified to the target threshold, and therefore the threshold can be made more likely to be modified and the dot omission is made more likely to be complemented, thus suppressing the drop in the image quality further. Also, uneven concentration of the formation position of the dot for complementing the dot omission can be suppressed and the drop in the image quality can be suppressed in this respect.

(4) In the above configurations (1) to (3), the modification unit may sequentially perform the search for the threshold in the order of the thresholds corresponding to the first and second pixels, the thresholds corresponding to the third and fourth pixels, and the thresholds corresponding to the fifth to eighth pixels until the search condition is satisfied. Thus, the threshold can be modified, giving a priority order to the pixels in the predetermined range, and therefore the position where the dot for complementing the dot that is not formed is likely to be formed can be controlled more easily.

(5) In the above-described configurations (1) to (4), the modification unit may modify the threshold higher than the change threshold among the thresholds corresponding to the pixels in the predetermined range, to the change threshold that is a target of the modification. Thus, not only the target threshold is modified to the change threshold, but also the threshold higher than the change threshold among the thresholds corresponding to the pixels in the predetermined range is modified to the change threshold modified to the target threshold, and therefore a dot is even more likely to be formed near the missing dot. Also, the dot for complementing the influence of the dot omission can be suppressed from being concentrated near the missing dot and causing a drop in the image quality. Such modification may be repeatedly performed until a specific end condition is satisfied, or may be performed a limited number of times such as only once or only twice.

(6) In the above configurations (1) to (5), the modification unit may not modify the change threshold when the target threshold is higher than a predetermined value. Thus, the modification of the corresponding threshold is performed only for a part of the pixels of the missing dots where no dot is formed, and therefore the time and effort of the modification processing can be reduced. Also, when the target threshold is higher than a predetermined value, dots are less likely to be formed in the first place, and therefore the influence on the image quality is small even if the threshold is not modified. Also, the threshold may be modified in all the cases.

(7) In the above configurations (1) to (6), the state of dot formation caused by the modification of the threshold by the modification unit may be adjusted. Thus, for example, when the formation of dots is unevenly concentrated at a specific place if the modification of the threshold is performed and left as it is, this can be adjusted.

(8) In the above configurations of (1) to (7), in the adjustment t of the state of dot formation, the threshold may be replaced so that a predetermined number or more of the modified thresholds are not arrayed next to each other. Thus, with such an adjustment, a situation where a predetermined number or more of dots are arrayed next to each other as a result of the modification of the threshold is less likely to occur, and the drop in the image quality can be suppressed. The adjustment may not be performed. Also, the adjustment of the state of dot formation is not limited to replacing the threshold so that a predetermined number or more of the modified thresholds are not arrayed next to each other, and may be not generating a part where the modified thresholds are arrayed at a predetermined ratio or higher.

(9) In the above configurations of (1) to (8), the adjustment of the state of dot formation may be increasing or decreasing the threshold or the input tone value corresponding to a pixel in a predetermined range and where a dot can be formed. Thus, the likelihood of formation of dots can be adjusted by increasing or decreasing the threshold or the input tone value. In general, when a missing dot is generated due to trouble such as a noise and a dot for substituting the missing dot is formed around the missing dot, there may be a case where the formation of the dot is insufficient and a case where the formation of the dot is excessive. In such cases, the formation of the dot can be made appropriate by increasing or decreasing the threshold or the input tone value corresponding to the pixel where a dot can be formed. The degree of increase or decrease may be adjusted by actually forming an image, or may be set in advance according to the tone value of the image.

(10) The present disclosure can also be implemented as a method of forming a dot on a medium by a head and thus performing printing. The method includes: preparing a dither mask including a plurality of thresholds used for halftone processing based on a dithering method; acquiring a position of a missing dot, which is a pixel where the dot is not formed by the head, from among on-pixels where the dot is formed; performing halftone processing of comparing an input tone value for each pixel forming image data with a threshold acquired according to a position of the pixel from the dither mask and thus converting the input tone value into dot data indicating whether to form a dot for each pixel; searching for a threshold used for the comparison at a pixel in a predetermined range near the missing dot, in the halftone processing, and when a change threshold, which is a threshold satisfying a search condition of being higher than a value of a target threshold, which is a threshold used for the comparison at the position of the missing dot, is found, modifying the change threshold to the target threshold and providing the modified threshold for the comparison at the pixel corresponding to the modified threshold in the halftone processing; and driving the head according to the dot data.

Thus, a dot is more likely to be formed near the missing dot, where a dot is not formed, and therefore the drop in the image quality due to missing dot can be suppressed. Also, since the threshold in the dither mask is modified, the drop in the image quality due to the missing dot, where a dot is not formed, can be suppressed more easily than when the input tone value is modified.

(11) The present disclosure may also be implemented as an image processing device that processes image data and converts the image data into dot data for forming dots on a medium. The image processing device includes: a dither mask unit that prepares a dither mask including a plurality of thresholds used for a halftone processing based on a dithering method; a halftone processing unit that compares an input tone value for each pixel forming image data with a threshold acquired according to a position of the pixel from the dither mask and thus converts the input tone value into dot data indicating whether to form a dot for each pixel; a missing dot acquisition unit that acquires a position of a missing dot, which is a pixel where the dot is not formed, from among on-pixels where the dot is formed; and a modification unit that searches for a threshold used for the comparison at a pixel in a predetermined range near the missing dot, and that, when a change threshold, which is a threshold satisfying a search condition of being higher than a value of a target threshold, which is a threshold used for the comparison at the position of the missing dot, is found, modifies the change threshold to the target threshold and provides the modified threshold for the comparison at the pixel corresponding to the modified threshold by the halftone processing unit. Thus, a dither mask for facilitating the formation of a dot near the missing dot, where a dot is not formed, can be easily provided. As a result, the drop in the image quality due to the missing dot can be suppressed by the use of the dot data processed by the image processing device. Also, since the threshold in the dither mask is modified, the drop in the image quality due to the missing dot, where a dot is not formed, can be suppressed more easily than when the input tone value is modified.

(12) In the above-described embodiments, a part of the configuration implemented by hardware may be replaced with software. At least a part of the configuration implemented by software can be implemented by a discrete circuit configuration. When a part or all of the functions according to the present disclosure are implemented by software, the software (computer program) can be provided in the form of being stored in a computer-readable recording medium. The “computer-readable recording medium” is not limited to a portable medium such as a flexible disc or a CD-ROM, and includes internal storage devices in a computer such as various RAMs and ROMs or an external storage device fixed to a computer such as a hard disk. That is, the term “computer-readable recording medium” has a broad meaning including any medium in which a data packet can be fixed, not temporarily.

The present disclosure is not limited to the above embodiments and may be implemented with various configurations without departing from the spirit and scope of the present disclosure. For example, technical features in the embodiments corresponding to technical features in the aspects described in the summary section can be replaced and combined as appropriate in order to solve a part or all of the above problems or in order to achieve a part of all of the above effects. The technical feature can be deleted where appropriate, unless described as essential in the present specification.

What is claimed is:

1. A printing device having a head that forms a dot on a medium, the printing device comprising:
a halftone processing unit that performs halftone processing of generating dot data indicating whether to form a dot, using image data including a plurality of pixels having a plurality of tone values and a dither mask including a plurality of thresholds;
a missing position acquisition unit that acquires a position of a missing dot in which the dot cannot be formed by the head despite a position where the dot is to be formed according to the dot data;
a modification unit that searches for a threshold used in generation of a dot in a predetermined range near the missing dot, modifies a value of a change threshold, which is a threshold satisfying a search condition of being higher than a value of a target threshold, which is a threshold used at the position of the missing dot, to a value equivalent to the value of the target threshold, and provides the modified threshold for the halftone processing at the pixel corresponding to the modified threshold; and
a printing unit that drives the head according to the dot data.

2. The printing device according to claim 1, wherein
the predetermined range is a range including pixels on both sides of the missing dot in a direction intersecting with an arrangement direction of the missing dot.

3. The printing device according to claim 1, wherein
the predetermined range is a range including a total of eight pixels made up of first and second pixels, which are pixels on both sides of the missing dot in a direction intersecting with an arrangement direction of the missing dot, third and fourth pixels, which are pixels further on the outer side of the pixels on both sides, and fifth to eighth pixels, which are pixels on both sides of the first and second pixels in the arrangement direction.

4. The printing device according to claim 3, wherein
the modification unit sequentially performs the search the for the threshold in order of the thresholds corresponding to the first and second pixels, the thresholds corresponding to the third and fourth pixels, and the thresholds corresponding to the fifth to eighth pixels until the search condition is satisfied.

5. The printing device according to claim 1, wherein
the modification unit modifies the threshold higher than the change threshold among the thresholds corresponding to the pixels in the predetermined range, to the change threshold that is a target of the modification.

6. The printing device according to claim 1, wherein
the modification unit does not modify the change threshold when the target threshold is higher than a predetermined value.

7. The printing device according to claim 1, wherein
a state of dot formation caused by the modification of the threshold by the modification unit is adjusted.

8. The printing device according to claim 7, wherein
in the adjustment of the state of dot formation, the threshold is replaced so that a predetermined number or more of the modified thresholds are not arrayed next to each other.

9. The printing device according to claim 7, wherein
the adjustment of the state of dot formation is increasing or decreasing the threshold corresponding to a pixel in a predetermined range and where the dot can be formed, or the tone value of the pixel.

10. A method of forming a dot on a medium by a head and thus performing printing, the method comprising:
acquiring a position of a missing dot in which the dot cannot be formed by the head despite a position where the dot is to be formed;
performing halftone processing of generating dot data indicating whether to form a dot, using image data including a plurality of pixels having a plurality of tone values and a dither mask including a plurality of thresholds;
searching for a threshold used in generation of a dot in a predetermined range near the missing dot, modifying a value of a change threshold, which is a threshold satisfying a search condition of being higher than a value of a target threshold, which is a threshold used at the position of the missing dot, to a value equivalent to the value of the target threshold, and providing the modified threshold for the halftone processing at the pixel corresponding to the modified threshold; and
driving the head according to the dot data.

11. An image processing device that processes image data and converts the image data into dot data for forming a dot on a medium, the image processing device comprising:
a halftone processing unit that performs halftone processing of generating dot data indicating whether to form a dot, using image data including a plurality of pixels having a plurality of tone values and a dither mask including a plurality of thresholds;
a missing position acquisition unit that acquires a position of a missing dot in which the dot cannot be formed despite a position where the dot is to be formed according to the dot data; and
a modification unit that searches for a threshold used in generation of a dot in a predetermined range near the missing dot, modifies a value of a change threshold, which is a threshold satisfying a search condition of being higher than a value of a target threshold, which is a threshold used at the position of the missing dot, to a value equivalent to the value of the target threshold, and provides the modified threshold for the halftone processing at the pixel corresponding to the modified threshold.
